(19) United States
(12) Patent Application Publication
(10) Pub. No.: US 2017/0036304 A1
(43) Pub. Date: Feb. 9, 2017

(54) OPTICAL GLASS AND METHOD OF CUTTING GLASS SUBSTRATE

(71) Applicant: ASAHI GLASS COMPANY, LIMITED, Chiyoda-ku (JP)

(72) Inventor: Hidetaka MASUDA, Haibara-gun (JP)

(73) Assignee: ASAHI GLASS COMPANY, LIMITED, Chiyoda-ku (JP)

(21) Appl. No.: 15/333,963

(22) Filed: Oct. 25, 2016

Related U.S. Application Data
(63) Continuation of application No. PCT/JP2015/062274, filed on Apr. 22, 2015.

(30) Foreign Application Priority Data
May 29, 2014 (JP) 2014-111762

(51) Int. Cl. B23K 26/53; G02B 5/20; C03B 33/09; B23K 26/00

(52) U.S. Cl. CPC B23K 26/53; B23K 26/0057; B23K 26/0006; G02B 5/208; C03B 33/091; B23K 2203/54

(57) ABSTRACT

Provided are a method of cutting a glass substrate which is capable of secure cutting by a simpler operation and an optical glass having high bending strength and dimension accuracy obtained by that method. The method of cutting the glass substrate comprising: forming selectively a plurality of reformed portions with a crack extending in the glass substrate from at least one of the plurality of reformed portions by radiating light to be focused inside the glass substrate so as to form a reformed region; and making a fracture occur in a thickness direction of the glass substrate along the reformed region so as to cut the glass substrate, wherein the crack has a tip portion at a depth of 3 to 20% of a thickness of the glass substrate from a cut surface, and an optical glass 100 is obtained by the above cutting method.

### CROSS-REFERENCE TO RELATED APPLICATIONS

This application is a continuation of prior International Application No. PCT/JP2015/062274 filed on Apr. 22, 2015 which is based upon and claims the benefit of priority from Japanese Patent Application No. 2014-111762 filed on May 29, 2014; the entire contents of all of which are incorporated herein by reference.

### FIELD

The present invention relates to an optical glass and a method of cutting a glass substrate, and particularly to an optical glass such as a cover glass or a near-infrared cut filter to be used by being bonded to a casing and a method of cutting a glass substrate used in manufacturing that optical glass.

### BACKGROUND

In semiconductor devices having solid state imaging devices such as a CCD (Charge Coupled Device) and a CMOS (Complementary Metal Oxide Semiconductor) to be used in digital still cameras and the like, optical glasses such as a near-infrared cut filter glass and a cover glass are used. In recent years, due to demands for a reduction in thickness of a solid state imaging device module to be mounted on a portable terminal such as a mobile phone or a smart phone and a reduction in thickness of a digital still camera, an optical glass having a small plate thickness is required.

However, when the plate thickness of the optical glass is reduced, it becomes increasingly likely that a fracture progresses starting from a chip or a microcrack existing in an edge line of the glass (boundary between a principal surface and a side surface of the glass) to cause breakage in a case where a bending stress acts on the optical glass.

Therefore, from a viewpoint of improving a bending strength of a glass, chamfering a glass edge surface has been proposed. The above aims at increasing a bending strength of a glass by removing flaws in its glass edge surface to be a starting point of a fracture by chamfering. Further, removing flaws in a principal surface of a glass plate by etching has been also proposed.

However, operations of the chamfering of a glass edge surface and the removing of flaws in a glass principal surface deteriorate (decrease) productivity of the optical glass. Further, a flaw is sometimes rather formed in the glass edge surface by the chamfering. This is caused because the chamfering of a glass is to mechanically process a glass with a grinding wheel. That is, an unintended flaw may be newly formed due to impact or the like during the chamfering. Further, when the etching is performed while holding the principal surface of the glass for the purpose of removing flaws in the principal surface of the glass, etching unevenness occurs on the principal surface being an optically effective surface, resulting in that optical characteristics as the optical glass may deteriorate (decrease).

In the meantime, as a method of cutting a semiconductor substrate and the like, there is known a technique of cutting the semiconductor substrate as a result that laser light with a wavelength passing through the semiconductor substrate (for example, silicon (Si)) is collected inside the semiconductor substrate to form a reformed region (flaw region) inside the semiconductor substrate, and then an external stress such as a tape expansion is applied to cause a crack in the semiconductor substrate starting from the reformed region.

This cutting method enables the reformed region to be locally and selectively formed inside the semiconductor substrate without damaging the principal surface of the semiconductor substrate. Therefore, it is possible to reduce occurrence of defects such as chipping in the principal surface of the semiconductor substrate that is a problem in general blade dicing. In addition, there are fewer problems such as dust occurrence unlike machining. Therefore, in recent years, the cutting method becomes to be widely used not only in cutting the semiconductor substrate but also in cutting a glass substrate.

### SUMMARY

The present inventor applied a cutting method by laser light when manufacturing an optical glass and confirmed that its cut surface is smooth and flaws and the like are not easily formed in an edge line. That is, it was found out that strength of the optical glass manufactured by this cutting method can be maintained to some extent without performing the operations such as the chamfering and the etching as described above.

The present invention is further aimed at providing an optical glass having higher bending strength and dimension accuracy obtainable by a simple operation in manufacturing of the optical glass by using this cutting method, and at providing a method of cutting a glass substrate.

As a result of earnest examinations for solving the above-described problems, the present inventors have found out that by making a crack occurring from a reformed region which occurs when laser light is made incident to a glass substrate have a predetermined size, an optical glass with higher bending strength and dimension accuracy can be obtained by a simple operation, and have completed the present invention.

In other words, an optical glass of the present invention is an optical glass comprising: a glass plate comprising a principal surface and an end surface; a reformed region formed on the end surface; a plurality of reformed portions formed by light radiated to be focused thereto in the reformed region; and a crack extending from the reformed portion on the end surface, having a tip portion at a depth of 3 to 20% of a plate thickness of the glass plate from the end surface.

Further, a method of cutting a glass substrate of the present invention comprising: forming selectively a plurality of reformed portions with a crack extending in the glass substrate from at least one of the plurality of reformed portions by radiating light to be focused inside the glass substrate so as to form a reformed region; and making a fracture occur in a thickness direction of the glass substrate along the reformed region so as to cut the glass substrate, wherein the crack has a tip portion at a depth of 3 to 20% of a thickness of the glass substrate from a cut surface.

According to an optical glass and a method of cutting a glass substrate of the present invention, it is possible to obtain an optical glass having a high bending strength and a high dimension accuracy.

### BRIEF DESCRIPTION OF THE DRAWINGS

FIG. 1 is a schematic view of a cutting apparatus for a glass substrate according to an embodiment of the present invention.

FIG. 2A is an explanatory view of a method of cutting a glass substrate which uses the cutting apparatus of FIG. 1.

FIG. 2B is an explanatory view of the method of cutting the glass substrate which uses the cutting apparatus of FIG. 1.

FIG. 2C is an explanatory view of the method of cutting the glass substrate which uses the cutting apparatus of FIG. 1.

FIG. 3A is a plan view of a glass substrate for explaining a reformed region of this embodiment.

FIG. 3B is an A-A cross-sectional view of the glass substrate of FIG. 3A.

FIG. 4 is a plan view to explain cracks in the glass substrate of FIG. 3A.

FIG. 5 is a view to explain a positional relationship of a reformed region in the glass substrate of FIG. 3A.

FIG. 6 is a side view of an optical glass according to an embodiment of the present invention.

FIG. 7 is a plan view of the optical glass of FIG. 6.

FIG. 8 is a sectional side view of a semiconductor device according to an embodiment of the present invention.

### DETAILED DESCRIPTION

Hereinafter, a method of cutting a glass substrate and an optical glass according to an embodiment of the present invention will be explained in detail with reference to the drawings.

[Method of Cutting Glass Substrate]

First, the method of cutting the glass substrate for manufacturing the optical glass of this embodiment will be explained with reference to the drawings.

<Cutting Apparatus for Glass Substrate>

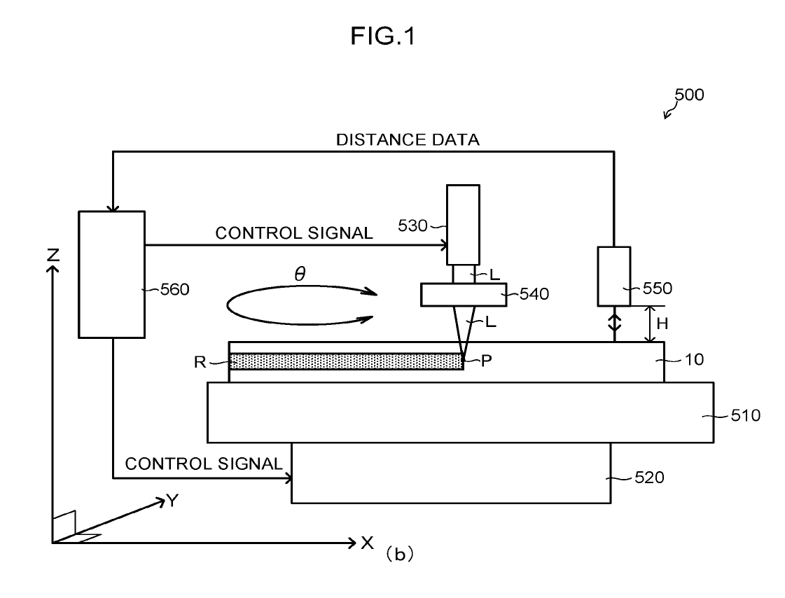

FIG. 1 is a schematic view of a cutting apparatus 500 for a glass substrate which is used in the method of cutting the glass substrate of this embodiment. As illustrated in FIG. 1, the cutting apparatus 500 includes: a table 510; a driving mechanism 520; a laser light radiation mechanism 530; an optical system 540; a distance measuring system 550; and a control mechanism 560.

The table 510 is a table for allowing a glass substrate 10 being a cutting object (a glass plate before being subjected to cutting to be manufactured into an optical glass 100) to be mounted. The glass substrate 10 is mounted on the table 510. Note that the table 510 is constituted so as to be movable in X, Y, and Z directions illustrated in FIG. 1. Further, the table 510 is constituted so as to be rotatable in a θ direction illustrated in FIG. 1 in an XY plane.

The driving mechanism 520 is coupled to the table 510 and moves, based on an instruction from the control mechanism 560, the table 510 in the horizontal directions (X and Y directions), the vertical direction (Z direction), and the rotation direction (θ direction). The laser light radiation mechanism 530 is a light source that radiates laser light L. Note that a YAG laser is preferably used for the light source. This is because the YAG laser can provide a high laser intensity and is power-saving and relatively inexpensive.

In a case of the YAG laser, a center wavelength of the laser light L to be output is 1064 nm, but nonlinear optical crystals are used to generate harmonics, and thereby laser light having a center wavelength of 532 nm (green) or laser light having a center wavelength of 355 nm (ultraviolet light) can also be obtained. In this embodiment, since the glass substrate 10 is to be cut, a light source to output laser light having the center wavelength of 532 nm is preferable. This is because the laser light having the center wavelength of 532 nm is the most transmittable through the glass substrate 10 and is suitable for cutting.

Note that a laser light radiation mechanism capable of radiating pulsed laser light is preferably used for the laser light radiation mechanism 530. Further, as the laser light radiation mechanism 530, one for which the wavelength, pulse width, repetition frequency, radiation time, energy intensity, and the like of the laser light L can be arbitrarily set according to a thickness (plate thickness) of the glass substrate 10 and a size of the reformed region to be formed is preferably used. Further, a radiation time of the pulsed laser light (time during which the laser light per pulse is radiated to the glass substrate) is preferably 100 picoseconds to 100 nanoseconds. By setting a reform time by the pulsed laser light to be within the aforementioned range, a reformed region suitable for cutting the glass substrate 10 can be formed. When the radiation time by the pulsed laser light is less than 100 picoseconds, a crack does not occur even if the reformed region is formed, resulting in that the glass substrate 10 may not be able to be cut. Further, when the radiation time by the pulsed laser light exceeds 100 nanoseconds, excessive cracks occur from the reformed region, resulting in that a bending strength after cutting of the glass substrate 10 may become low.

The optical system 540 includes an optical lens, and converges the laser light from the laser light radiation mechanism 530 to the inside of the glass substrate 10. In other words, the optical system 540 forms a light collecting part P inside the glass substrate 10, enabling formation of the reformed region R inside the glass substrate 10. The distance measuring system 550 is, for example, a laser distance meter and measures a distance H to the principal surface of the glass substrate 10 by a triangulation method. The distance measuring system 550 measures the distance H to the principal surface of the glass substrate 10 at predetermined time intervals (for example, every several milliseconds), and outputs the measured distance H to the control mechanism 560.

The control mechanism 560 controls the driving mechanism 520 to move the table 510 so that the laser light is radiated along a cutting line (hereinafter, a planned cutting line) planned on the glass substrate 10, and the laser light radiation mechanism 530 radiates the laser light to the glass substrate 10. Further, the control mechanism 560 adjusts the height of the table 510 based on distance information output from the distance measuring system 550. Incidentally, the control mechanism 560 may also adjust the position of the lens of the optical system 540 based on the distance information output from the distance measuring system 550.

More specifically, the control mechanism 560 controls the driving mechanism 520 to adjust the position of the glass substrate 10 in the height direction (Z direction) so that the distance H between the optical system 540 and the glass substrate 10 fall within a fixed range (for example, ±5 μm). As for a position of the reformed region R, the height of the glass substrate 10 is adjusted as above to bring the light collecting part P of the laser light to a desired position in a thickness direction of the glass substrate 10.

<Cutting of Glass Substrate>

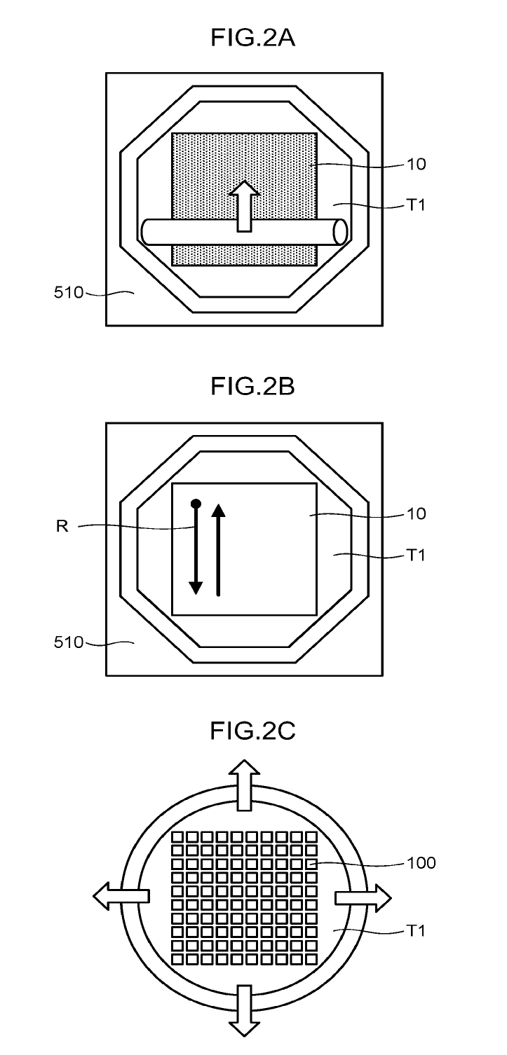

FIG. 2A to FIG. 2C are explanatory views regarding cutting of the glass substrate 10. Hereinafter, the cutting of the glass substrate 10 will be explained with reference to FIG. 2A to FIG. 2C.

(Preparation Step)

In this step, first, the glass substrate 10 is bonded to a tape T1 for expansion, and the glass substrate 10 is mounted on the table 510 of the cutting apparatus 500 explained with reference to FIG. 1 (FIG. 2A). Note that the single glass substrate 10 is bonded to the tape T1 in FIG. 2A, but the number of glass substrates 10 to be bonded to the tape T1 may also be plural.

(Reforming Step)

Next, the cutting apparatus 500 is used to radiate the laser light from the laser light radiation mechanism 530 to the glass substrate 10 along the planned cutting line by the optical system 540 so that the light is focused inside the glass substrate 10, to thereby selectively form the reformed region R inside the glass substrate 10 (FIG. 2B).

The planned cutting line is typically a lattice-patterned scanning line made so that a planar shape of the optical glass obtained by cutting becomes a square shape or rectangular shape. Here, the light collecting part P of the laser light formed inside the glass substrate 10 may be dot-shaped or may be linear. Such light collecting parts P are intermittently reformed at predetermined pitch intervals, to thereby form the reformed region R.

(Cutting Step)

After reforming of the planned cutting line is finished, next, by expanding the tape T1 in outline arrow directions, a tensile cutting stress is applied to the glass substrate 10. Thereby, the glass substrate 10 is cut into individual pieces along the planned cutting lines starting from the reformed region R formed in the glass plate 10, whereby optical glasses 100 are obtained (FIG. 2C). FIG. 2C illustrates an example in which the planned cutting lines are formed in a lattice pattern so that the plurality of optical glasses 100 whose planer shapes are square can be obtained.

Hereinafter, the reforming step being a characteristic of the present invention will be explained further in detail.

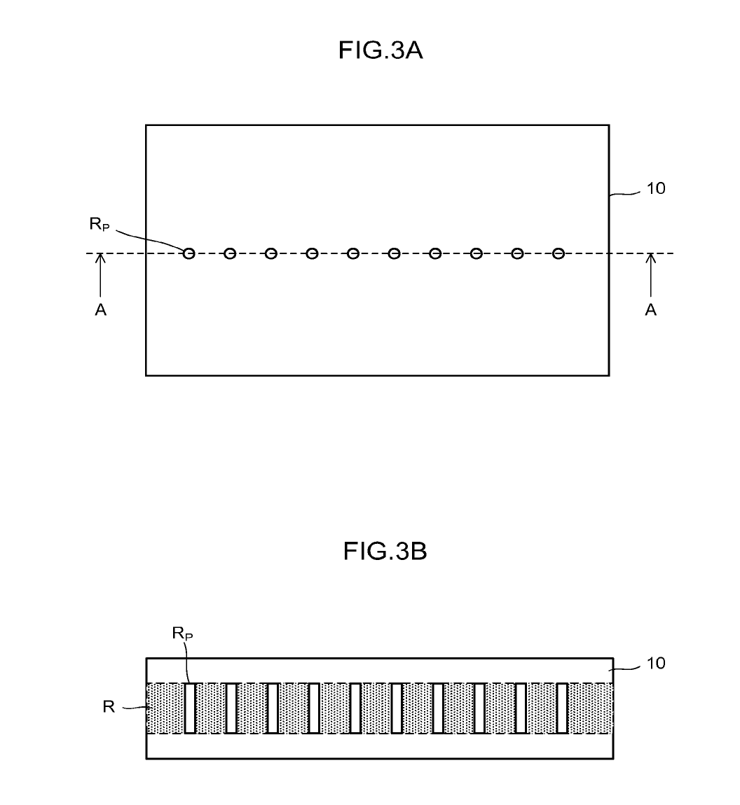

FIG. 3A and FIG. 3B schematically illustrate a glass substrate for explaining the reformed region R formed inside the glass substrate 10, FIG. 3A being a plan view of the glass substrate 10 and the FIG. 3B being an A-A cross-sectional view of the glass substrate 10 of FIG. 3A.

As illustrated in FIG. 3A and FIG. 3B, the reformed region R is formed as an aggregate of a plurality of reformed portions Rₚ. The reformed portion Rₚ is formed to have a shape corresponding to the light collecting part P of the laser light. As a result that the plurality of reformed portions Rₚ are formed intermittently at predetermined pitches along the planned cutting line, the belt-shaped reformed region R is formed. In FIG. 3B, the reformed region R is indicated by a dotted hatching pattern (however, the reformed portions Rₚ having been directly reformed by the laser light are indicated by white spaces for the sake of explanation).

At this time, a width in the plate thickness direction of the reformed region R is preferably 13 to 50% in length to a plate thickness t of the glass substrate. If the width in the plate thickness direction of the reformed region R is too small, the reformed region is far to a substrate surface, so that a crack made to extend in the cutting step may not reach the substrate surface, resulting in that cutting may not be able to be performed or meandering may become large. If the width in the plate thickness direction of the reformed region R is too large, the reformed region R is close to the substrate surface, resulting in that the bending strength may be reduced.

A pitch between the reformed portions Rₚ is preferably within a range of 3.0 to 38 μm, and is more preferably within a range of 7.5 to 20 μm. A scanning speed of the laser light becomes slower as the pitch becomes narrower, bringing about a reduced productivity, and when the pitch is less than 3.0 μm, the reformed portions overlap each other and the crack does not occur well, resulting in that cutting may not be able to performed. Further, when the pitch exceeds 38 μm, the reformed portions are far from each other and the cracks having occurred are not connected well, resulting in that cutting may not be able to be performed. As described above, the pitch within the above-described range enables efficient cutting of the glass, so that an optical glass of a desired shape can be obtained.

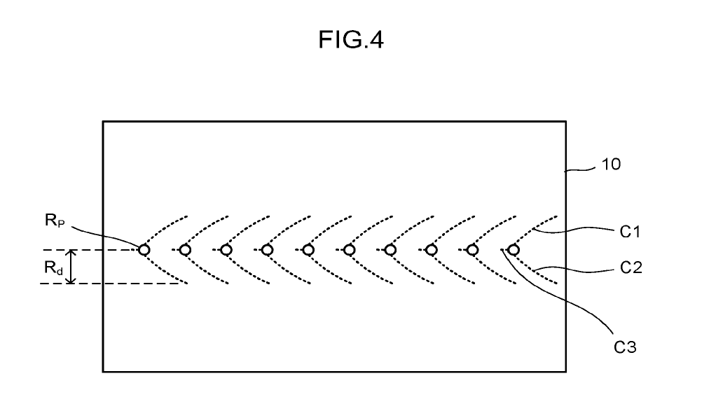

Incidentally, it is found out that, by this reforming step, in forming the reformed portions Rₚ intermittently by the laser light, cracks tend to occur in three directions (C1, C2, C3) of up-down directions and the planar direction of the plate thickness extending from the reformed portions Rₚ. FIG. 4 is a plan view which illustrates the glass substrate 10 partially enlarged for explaining the cracks occurring from the reformed portions Rₚ in the glass substrate 10. As for these cracks C1 to C3, as illustrated in FIG. 4, the cracks C1 and C2 tend to occur starting from the reformed portions Rₚ in a manner to broaden in right and left on a laser light scanning direction side from the planned cutting line, and the crack C3 tends to occur in a reverse direction to the laser light scanning direction. At this time, though the crack C3 becomes a part of an actual cutting line, the cracks C1 and C2 remain inside the glass after the cutting. Note that all the cracks C1 to C3 are normally formed inside the glass substrate 10.

Here, a reformed region tip depth R_{d} means a distance from the planned cutting line to a tip of the crack C1 or a distance from the planned cutting line to a tip of the crack C2 in a direction orthogonal to the planned cutting line, and is the maximum value in a measured region having a width of 5 mm or more or including 100 or more reformed portions. Illustrated in FIG. 4 is a view for explaining the reformed region tip depth R_{d}. The reformed region tip depth R_{d} is set to 3 to 20% in length of the plate thickness t of the glass substrate 10. In other words, the crack C1 or the crack C2 has a tip portion at a depth of 3 to 20% of the thickness of the glass substrate. When the reformed region tip depth R_{d} is less than 3% of the plate thickness t, the cracks do not extend sufficiently by a tensile stress applied in the cutting step, resulting in that the cutting may not be able to be performed. On the other hand, when the reformed region tip depth R_{d} exceeds 20% of the plate thickness t, the bending stress is excessively reduced, resulting in that, in a cross section of the optical glass after the cutting, the glass may be chipped or peeled in manufacturing a product or in usage, and thus application to a product is sometimes difficult.

The reformed region tip depth R_{d} is influenced by the kind (in particular, a hardness, a fracture toughness value, a thermal expansion coefficient, or the like) of the glass substrate, energy of the laser light at the time of reforming, a shape of the light collecting part, a scanning speed, a radiation time, and so on, and thus a condition can be properly selected to fulfill the above-described range. As the glass substrate, one with 0.2 MPa·m^{1/2}<fracture toughness value K_{1c}<0.74 MPa·m^{1/2} is preferable.

In this reforming step, the light collecting part P of the laser light desirably has a vertically long shape extending in the plate thickness direction. Thereby, even if the number of scannings of the laser light along the planned cutting line is decreased, cutting can be performed easily and well. When the laser light is scanned without correction of the shape of the light collecting part P, it is difficult to control the width of the reformed region R and the reformed region tip depth R_{d} separately. Both width of the reformed region R and reformed region tip depth R_{d} become large in proportion to the energy of the laser light, and if the width of the reformed region R is made large to a desired range for the sake of secure cutting, the reformed region tip depth R_{d} becomes excessively large, bringing about a tendency that quality of the optical glass after the cutting becomes bad. In the meantime, when the reformed region tip depth R_{d} is made small to a desired range for the sake of higher quality of the optical glass after the cutting, the width of the reformed region R becomes excessively small, resulting in that the cutting may not be able to be performed. However, by making the light collecting part P have the vertically long shape extending in the plate thickness direction in advance, it becomes possible to broaden the width of the reformed region R by a method other than using the energy of the laser light, so that it becomes easy to suppress the reformed region tip depth R_{d} to be small within the desired range while making the width of the reformed region R large to the desired range. Therefore, even in a case where the cutting cannot be performed well unless the light collecting part is scanned a plurality of times to form the reformed region R while the position of the light collecting part is changed in the plate thickness direction, by the method in which the light collecting part is corrected to have the vertically long shape, sufficient cutting is possible even by the reduced number of scannings of the laser light, so that an optical glass having a desired shape can be manufactured easily by a simple operation.

Incidentally, in order to make the shape of the light collecting part P be the vertically long shape extending in the plate thickness direction of the glass substrate 10, for example, adjustment by using a holography technique is possible.

For using the holography technique, it suffices to provide a means storing a hologram pattern adjustable to a desired light collecting shape such as, for example, a diffraction lens and a spatial light modulator in a light path of the laser light. For example, as the diffraction lens used here, there can be cited one obtained by processing projections and depressions in a surface of a quartz glass substrate or the like so as to be able to express a hologram pattern. Here, for the processing of the projections and the depressions, for example, a method of making a groove in a desired shape by a photolithography technique can be cited. Further, in a case of displaying the hologram pattern by providing the spatial light modulator in the light path of the laser light, examples of its display method include ones using a liquid crystal display element, a digital micromirror device (micromirror array structure), and a magneto-optical effect.

Examples of the method for creating the hologram pattern include a method of directly photographing interference fringes occurring by radiation of laser light to an object, a method of calculating by a computer (CGH), and a method of using an integral photography system. The computer-generated hologram (CGH) is preferable in that the desired shape can be obtained easily.

In this embodiment, when the laser light is scanned a plurality of times with the position being changed in the plate thickness direction of the glass substrate 10, the positions of the plurality of reformed portions formed by the scannings of the laser light are shifted in the plate thickness direction and made to be matched in the scanning direction, whereby it is possible to form the reformed portions Rₚ extending longer in the plate thickness direction than the light collection part P. As described above, even by the method of making the width in the plate thickness direction of the reformed region R large by increasing the number of scannings while lowering the energy of the laser light, it is possible to suppress the reformed region tip depth R_{d} to be small within the desired range while making the width of the reformed region R be large to the desired range.

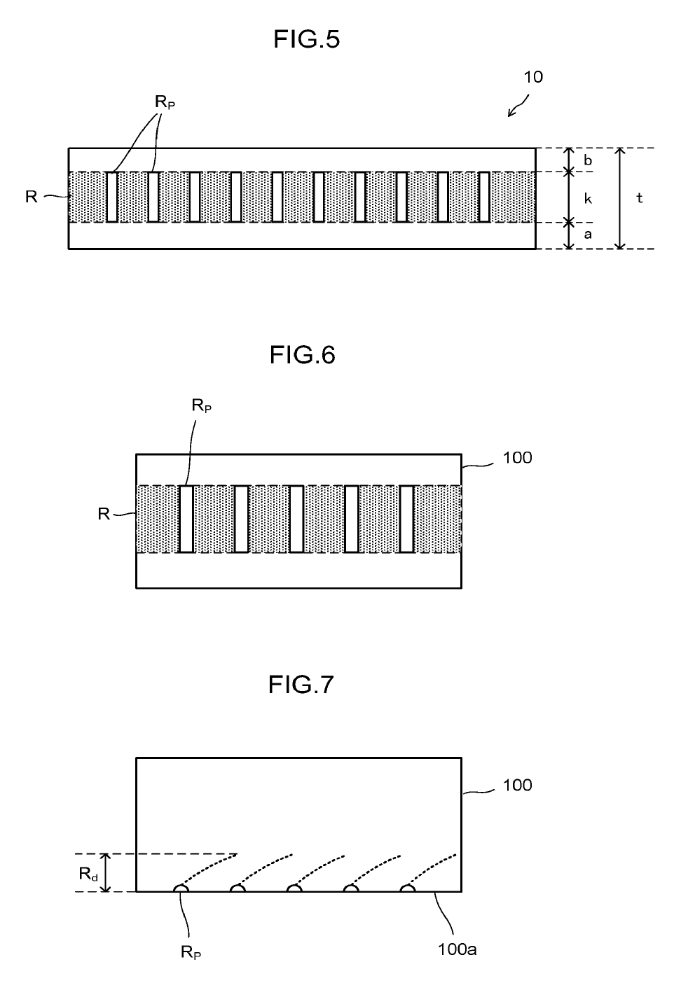

The forming position of the reformed region R is not limited in particular as long as good cutting can be performed in the cutting step. FIG. 5 is a view for explaining the positional relationship of the reformed region in the A-A cross-sectional view illustrated in FIG. 3B. In FIG. 5, as for the forming position of the reformed region R, in the plate thickness direction of the glass substrate 10, a distance from one principal surface to the reformed region R is set to a, a distance from the other principal surface to the reformed region R is set to b, the plate thickness of the glass substrate 10 is set to t, and the width of the reformed region R is set to k. At this time, the reformed region R may be formed by a single scanning or maybe formed by a plurality of scannings. Further, though the reformed region R is indicated as one belt-shaped reformed region in FIG. 5, the reformed region R may be formed in a state where a plurality of reformed portions are separated in the plate thickness direction as a result of the plurality of scannings of the laser light along the planned cut line (that is, two or more belt-shaped reformed regions may be formed in parallel). In a case where the plurality of reformed portions are separately formed in the plate thickness direction, the distance a from the one principal surface of the glass substrate 10 to the reformed region R means a distance from the one principal surface to the nearest reformed region. Further, similarly, the distance b from the other principal surface of the glass substrate 10 to the reformed region R means a distance from the other principal surface to the nearest reformed region.

Here, the distance a from the one principal surface to the reformed region means a distance between a point where a peak count value Pc of the cut surface (value measured in the direction parallel to the principal surfaces) is confirmed in a direction from the one principal surface to the other principal surface to be greater than 20 for the first time and the one principal surface. Similarly, the distance b from the other principal surface to the reformed region means a distance between a point where the peak count value Pc of the cut surface (value measured in the direction parallel to the principal surfaces) is confirmed in a direction from the other principal surface to the one principal surface to be greater than 20 for the first time and the other principal surface.

Here, the distance a and the distance b are numerical values greater than 0 (zero), which means that it is essential for the reformed region R to be formed apart from the respective principal surfaces (translucent surfaces) of the glass substrate. Further, the reformed region R is preferably formed a certain distance or more apart from the respective principal surfaces, and for example, the distance a and the distance b are each preferably equal to or more than the thickness t of the glass substrate 10×0.1 (namely, plate thickness×10%).

The width k of the reformed region is the same as a height (vertical width) in the plate thickness direction of the reformed region R, and is also represented as t−(a+b). The width k of the reformed region is preferably 13 to 50% in length to the plate thickness t of the glass substrate as described in the above explanation of the reformed portion R. When the width k of the reformed region is less than 13%, the cutting may not be able to be performed, or a meandering amount of the edge may become large even if the cutting can be performed, and when the width k exceeds 50%, the reformed region is too close to the substrate surface, resulting in that the bending strength may be reduced.

Further, the reformed region R is preferably provided in a center position of the plate thickness as much as possible, and is preferably provided in a position where, for example, |a−b|/2 is equal to or less than 0.05 t. At this time, the tip of the crack C formed starting from the reformed portion Rₚ is positioned in almost the center of the width k of the reformed region, and thus as a result that |a−b|/2 satisfies the above-described relationship, the tips of the cracks C1 and C2 are also provided near a center position of the plate thickness. The tips of the cracks C1 and C2 are more preferably within a range of ±10 μm in the plate thickness direction from the center of the plate thickness of the glass substrate 10. The above leads to little bias of the cracks, so that the strength of the optical glass can be secured in cutting and manufacturing and an unnecessary chip or peeling can be prevented.

The plate thickness of the glass substrate 10 is not limited in particular, but for example, the glass substrate of 100 μm to 1 mm in thickness is preferable and the glass substrate of 100 μm to 500 μm in thickness is more preferable. The required width k of the reformed region R becomes larger as the plate thickness becomes greater, and with the plate thickness of 500 μm or more, twice or more scannings may be required even if the light collecting part P has the vertically long shape in the plate thickness direction. In a case of a cover glass used for a semiconductor device, the glass substrate is preferably a comparatively thin substrate of 100 to 300 μm as its micronization or reduction in weight is required.

Note that the reformed region R and the remaining region can be determined, after the glass substrate 10 is cut to the optical glass 100, by the peak count value of its cut surface. The peak count value Pc means the number of peaks in an evaluation length, counted by a method of setting a range exceeding a negative reference level (−H) to exceeding a positive reference level (+H) as one peak with a mean line of curves expressing a surface state (irregularities) of an object to be measured being the center, which is defined by American Society of Mechanical Engineers ASME B46.1 (1995).

In this embodiment, the peak count value is first measured on the cut surface of the optical glass 100 in the direction parallel to the respective principal surfaces. This measurement is performed a plurality of times while changing the position in the plate thickness direction of the optical glass 100. Then, while using the peak count values at the positions in the plate thickness direction on the cut surface of the optical glass 100, the peak count values Pc measured in the direction from the one principal surface to the other principal surface are confirmed and the distance between the measurement position where the peak count value Pc exceeds 20 for the first time and the one principal surface is set to the distance a. In the same manner, while using the peak count values at the positions in the plate thickness direction on the cut surface of the optical glass 100, the peak count values Pc measured in the direction from the other principal surface to the one principal surface are confirmed and the distance between the measurement position where the peak count value Pc exceeds 20 for the first time and the other principal surface is set to the distance b.

As long as this peak count value measurement is performed while confirming a boundary position between the reformed region R and the remaining region based on an optical micrograph of the cut surface, the distance a and the distance b can be determined efficiently and precisely. Further, when the measurement position is changed in the plate thickness direction, the measurement is preferably performed at an interval equal to or less than the plate thickness t of the glass substrate 10×0.04 (namely plate thickness×4%) in the vicinity of the boundary position between the reformed region R and the remaining region in particular. This enables more precise boundary position determination.

Incidentally, the peak count value of the cut surface can be obtained as the number of peaks defined by the following manner. Namely, one peak can be given by a form starting from a point exceeding below a dead zone set on a measured waveform measured in the direction parallel to the respective principal surfaces, via a point exceeding above the dead zone on the measured waveform, to a point again exceeding below the dead zone on the measured waveform as a unit. The width of the dead zone (the dead zone width) is given as the maximum height of the measured waveform×0.05 with respect to the mean line of the measured waveform as a center.

The measurement is performed using a laser microscope (shape measurement laser microscope VK-X100 and analysis software: VK-H1XA manufactured by KEYENCE CORPORATION), and its condition is set as follows: evaluation length (measurement width): 725 μm (magnification: 200 times); wavelength: 628 nm; and no measured waveform correction in the analysis software.

As described above, according to the method of cutting the glass substrate according to this embodiment, the reformed region R is formed inside the glass substrate 10, so that the glass substrate 10 can be cut easily. Further, the crack which occurs starting from the reformed portion Rₚ of the reformed region R is suppressed to be comparatively small. As a result of the above, it is possible to obtain an optical glass 100 with a good bending strength and a good dimension accuracy.

[Optical Glass]

FIG. 6 illustrates a side view of the optical glass according to the embodiment of the present invention. A side surface of this optical glass 100 is a cut surface itself cut along the above-described reformed region R. That is, this optical glass 100 is obtained in a manner that the reformed region R is formed by laser light inside the glass substrate before being cut to cut a desired shape and size and exterior force is applied to the glass substrate to thereby cut the glass substrate along the reformed region R. Therefore, the reformed region R is exposed on the side surface of this optical glass 100, and the optical glass 100 has a cut surface cut in a plate thickness direction of the glass along the reformed region R. Further, this optical glass 100 is a plate-shaped glass obtained by cutting the glass substrate 10 as described above.

This optical glass 100 is obtained as a result of being cut by the above-described method of cutting the glass substrate, in the reformed region R its cut surface has, the reformed portions Rₚ by the laser light being formed intermittently at predetermined pitches as described above, and the optical glass 100 is formed by adjusting its processing condition so that a size of the crack which occurs starting from the reformed portion Rₚ is within a predetermined range.

Further, this reformed region R is the reformed region R exposed on the cut surface, the reformed region R having been formed inside the glass substrate 10 illustrated in FIG. 5, and has the same relationship as the relationship of the distances a, b, and the width k in the reformed region R formed by the above-described method of cutting the glass substrate.

Note that similarly the cracks C1 to C2 formed extending from the reformed portion Rₚ are the same as those in the above-described explanation. FIG. 7 is a plan view of the optical glass 100 of FIG. 6, in which the cut surface cut along the planned cut line constitutes an outline of the optical glass 100. Since this cut surface is made by cutting along the reformed region R, each of the cracks C1 to C2 which do not contribute to the cutting among the cracks extending from the reformed portions Rₚ remains in one of both sides of the cut optical glass.

That is, the position of the reformed region R in the cut surface has the same relationship as that explained in the above-described cutting method, in which the distance a and the distance b are numerical values greater than 0 (zero), and for example, the distance a and the distance b are each preferably equal to or more than the thickness t of the glass substrate 10×0.1 (namely, plate thickness×10%). The width k of the reformed region is the same as the height (vertical width) in the plate thickness direction of the reformed portion Rₚ and is preferably 13 to 50% in length to the plate thickness t of the glass substrate. Further, the tip of the crack C formed starting from the reformed portion Rₚ is preferably within a range of ±10 μm in the plate thickness direction from the center of the plate thickness of the glass substrate 10. Further, a distance from the cut surface to the tip of the crack C1 or C2 is each referred to as a reformed region tip depth R_{d}. This reformed region tip depth R_{d} is set to 3 to 20% in length of the plate thickness t of the glass substrate 10. Note that the reformed region tip depth R_{d} described here is practically synonymous with the reformed region tip depth R_{d} explained in the paragraph 0037.

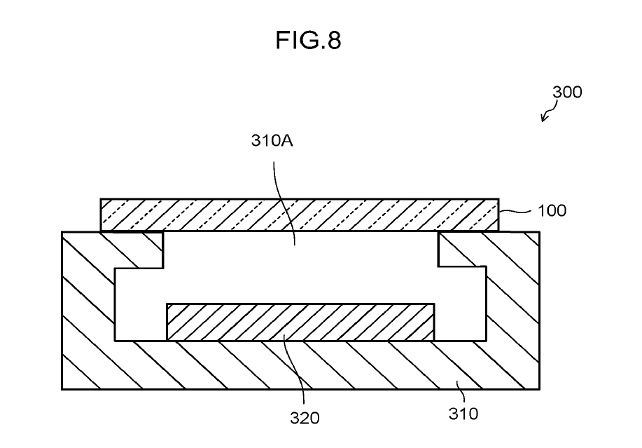

This optical glass 100 is, for example, bonded to a casing so as to cover an opening portion of the casing, and used as a cover glass. FIG. 8 illustrates a cross-sectional view of a semiconductor device 300 with the optical glass 100 applied to a casing 310. Here, the optical glass 100 is bonded to the casing 310 so as to cover an opening portion 310A of the casing 310.

Incidentally, the semiconductor device 300 described here is made by housing a semiconductor element 320 in the casing 310, the optical glass 100 of this embodiment is bonded to the casing 310 so as to cover the opening portion 310A of the casing 310, and the casing 310 is airtightly sealed. Here, the bonding is made by sealing a bonding region of one principal surface of the optical glass 100 and a casing forming the opening portion 310A of the casing 310 with a thermosetting resin, an ultraviolet curing resin, or the like.

Further, as long as being a well-known one, the semiconductor element 320 can be used without any limitation in particular, and solid state imaging devices (for example, a CCD and a CMOS) and the like are exemplified. Particularly, a semiconductor device to be applied to a mobile portable electronic device is preferable because it is highly likely to receive a drop impact or the like.

The optical glass 100 applied to the casing as described above is preferably formed of glass having a fracture toughness in a range of 0.2 MPa·m^{1/2} to 0.74 MPa·m^{1/2} and having a thermal expansion coefficient in a range of 75×10⁻⁷/K to 150×10⁻⁷/K, with the glass substrate 10 being a material.

When the fracture toughness of the glass substrate 10 exceeds 0.74 MPa·m^{1/2}, cracks are unlikely to occur in the reformed region R at the time of forming the reformed region R in the glass substrate 10 by laser light, resulting in difficulty in cutting the glass substrate 10. Further, at the time of cutting the glass substrate 10 starting from the reformed region R, cracks are unlikely to extend in the plate thickness direction, so that the glass substrate 10 is forcedly cut, resulting in a rough cut surface of the optical glass 100 and a decreased dimensional accuracy. Further, even if the cracks occurring in the reformed region R are formed to be large so as to sufficiently extend, cracks extending in directions other than the plate thickness direction also become large, resulting in a rough cut surface of the optical glass 100 after cutting. This may decrease the dimensional accuracy and the bending strength of the optical glass 100.

On the other hand, when the fracture toughness of the glass substrate 10 is less than 0.2 MPa·m^{1/2}, cracks starting from the reformed portion Rₚ are too likely to occur at the time of forming the reformed region R in the glass substrate 10 by laser light, and therefore, cracks reaching the surface of the glass substrate 10 are formed from the reformed portion Rₚ of the glass substrate 10, bringing about a problem that the cut optical glass 100 is likely to be chipped or cracked. Further, even if cracks are formed to be small so that cracks reaching the surface of the optical glass 100 from the reformed portions Rₚ are not formed, the cracks are likely to excessively extend starting from the reformed portion Rₚ, and therefore, cracks extend also in directions other than the plate thickness direction, resulting in a rough cut surface of the optical glass 100. This may decrease the dimensional accuracy and the bending strength of the optical glass 100. Further, when the fracture toughness is less than 0.2 MPa·m^{1/2}, cracks existing in the cut surface of the optical glass 100, even if minute, cause breakage, so that the optical glass 100 after cutting may have a bending strength not enough for practical use.

When the thermal expansion coefficient of the glass constituting the optical glass 100 exceeds 150×10⁻⁷/K, cracks are formed too large in the reformed region R at the time of forming the reformed region R inside the glass by laser light, resulting in significant decrease in dimensional accuracy and bending strength of the optical glass 100 after cutting. On the other hand, when the thermal expansion coefficient of the optical glass 100 is less than 75×10⁻⁷/K, cracks are unlikely to occur in the reformed region R at the time of forming the reformed region R inside the glass by laser light, resulting in difficulty in cutting.

The fracture toughness of the glass substrate is a value (K1c) calculated by the following expression in the indentation fracture method OF method) defined by ES R1607. Incidentally, measurement of the fracture toughness of the glass substrate is performed by using a Vickers hardness meter (ARS 900F and analysis software: FT-026 manufactured by FUTURE-TECH CORP.) under an environment condition of 23° C. in room temperature and 30% in humidity. Further, in this measurement, a crack extends from an indentation formed by an indenter and grows with time passage. Thus, measurement of a crack length is performed within 30 seconds after the indenter is released from the glass substrate.

K1c=0.026·E^{1/2}·P^{1/2}·a·C^{3/2}

In the above expression, E represents a Young's modulus, P represents an indentation load, a represents ½ of the average of indentation diagonal line lengths, and C represents ½ of the average of crack lengths.

The thermal expansion coefficient of the glass substrate, measured by the differential expression defined by JIS R3102, is an average value of values measured at 50° C. to 300° C.

For the optical glass 100, a material to be used can be appropriately selected from materials transparent in a visible wavelength region. For example, a borosilicate glass is processed easily and can suppress occurrence of flaws, foreign matters, and the like on an optical surface, thus being preferable, and a glass containing no alkaline component has good adhesiveness, weather resistance, and the like, thus being preferable.

As the glass used here, it is also possible to use a light absorbing glass having absorption in an infrared wavelength region, which is obtained by adding CuO or the like to a fluorophosphate-based glass or a phosphate-based glass. Particularly, the fluorophosphate-based glass or phosphate-based glass having had CuO added thereto has high transmittance to light of a visible wavelength region, and additionally can give a good near-infrared light cut function because CuO sufficiently absorbs light of a near-infrared wavelength region.

Specific examples of the fluorophosphate-based glass containing CuO include glasses containing, in cation %, 20 to 45% of P⁵⁺, 1 to 25% of Al³, 1 to 30% of R⁺ (where R⁺ is the total content of Li⁺, Na⁺, and K⁺), 1 to 15% of Cu²⁺, and 1 to 50% of R²⁺ (where R²⁺ is the total content of Mg²⁺, Ca²⁺, Sr²⁺, Ba²⁺, and Zn²⁺), and in anion %, 10 to 65% of F⁻, and 35 to 90% of O²⁻. As a commercially available product, an NF-50 glass (manufactured by AGC TECHNO GLASS CO., LTD.) and the like are exemplified.

Specific examples of the phosphate-based glass containing CuO include glasses containing, in mass % in terms of the following oxides, 25 to 74% of P₂O₅, 0.1 to 10% of Al₂O₃, 0 to 3% of B₂O₃, 0 to 10% of Li₂O, 0 to 10% of Na₂O, 3 to 15% of Li₂O+Na₂O, 0 to 2% of MgO, 0 to 2% of CaO, 0 to 5% of SrO, 0 to 9% of BaO, 0 to 15% of MgO+CaO+SrO+BaO, and 0.5 to 20% of CuO.

Incidentally, a glass composition is not limited to the ones described above, and an appropriate glass can be used.

The thickness of the optical glass 100 is not limited in particular, but from the standpoints of reduction in size and reduction in weight, the 0.1 to 1 mm range is preferable, and the 0.1 to 0.5 mm range is more preferable.

Further, in the optical glass of this embodiment, an optical thin film can also be formed on the principal surfaces of the optical glass 100 as necessary. Examples of the optical thin film include an infrared cut filter and an anti-reflection film, and include a single layer film of MgF₂, a multilayer film made by stacking a mixture film of Al₂O₃.TiO₂ and ZrO₂ and MgF₂, and an alternate multilayer film of SiO₂.TiO₂. The single layer film or multilayer film is formed on the principal surface of the optical glass 100 by a film forming method such as vacuum deposition or sputtering. The physical film thickness of the optical thin film is preferably 0.2 μm to 8 μm.

Further, examples of the optical thin film include a UVIR cut filter that cuts ultraviolet light (UV) and infrared light (IR), which is composed, for example, of a multilayer film made by stacking dielectric films different in refractive index such as SiO₂.TiO₂, a resin film containing an ultraviolet absorbent and an infrared absorbent, or the like. The multilayer film can be formed by a film forming method such as vacuum deposition or sputtering, and the resin film can be formed on the principal surface of the optical glass 100 by a well-known film forming method in which a resin dispersed or dissolved in a solvent is applied to be dried. Further, the physical film thickness of the optical thin film is preferably 0.2 μm to 8 μm.

### Examples

Hereinafter, the present invention will be explained in detail based on Examples and Comparative examples, but the present invention is not limited only to Examples.

### Example 1 to Example 21

In the following explanation, Examples 1, 2, 4 to 7, 9 to 17, and 19 to 21 are Examples, and Examples 3, 8, and 18 are Comparative examples.

As the glass substrate, plate-shaped fluorophosphate glasses of two kinds of thicknesses (NF-50 manufactured by AGC TECHNO GLASS CO., LTD., 150 μm and 300 μm in plate thickness, 100 mm×100 mm in dimension) were prepared. This glass substrate is a glass in the composition range of the above specific examples described as the fluorophosphate-based glass containing CuO. This glass substrate has a thermal expansion coefficient of 129×10⁻⁷/K and has a fracture toughness of 0.44 MPa·m^{1/2}.

This glass substrate was cut into square shapes of 5 mm×5 mm under cutting conditions described below, and optical glasses having cut surfaces including the reformed regions on their side surfaces were manufactured.

The following conditions were used in the step of selectively forming the reformed region inside the glass substrate. A YAG laser (with a center wavelength of 1064 nm) was used as the laser light source and modulated to make laser light with a center wavelength of 532 nm incident on the glass substrate. Further, for the laser output, an appropriate output was selected so that the reformed region does not reach the glass substrate principal surface and that average laser energy per pulse becomes 3 to 20 μJ. The laser light was adjusted so as to be incident from one principal surface side in the plate thickness direction of the glass substrate to be focused at a predetermined position.

Incidentally, at this time, a light-collecting shape by the laser light was adjusted to become vertically longer in the plate thickness direction than an aberration occurring by a refractive index of the glass so that reformed regions illustrated in a table can be obtained. The reformed portions Rₚ were formed along the planned cutting line intermittently at predetermined pitches inside the glass substrate by the above light-collecting shape, to thereby form the reformed region.

Next, the glass substrate having had the reformed region formed therein was bonded to an expansible resin film and the resin film was pulled in the planar direction of the glass substrate, to thereby extend cracks formed in the reformed region in the glass substrate up to the principal surface of the glass substrate. Thereby, a fracture occurred in the thickness direction of the glass substrate and the glass substrate was cut along the reformed region, so that the optical glass was obtained.

The process condition, parameters of the positional relationships of the reformed region in the cut surface of the obtained optical glass (t, a, b, and k in FIG. 5), the reformed region tip depth R_{d}, the 4-point bending strength of the optical glass (relative ratio in the case of the strength in Example 3 being 1.0), and the meandering amount of the edge at this time are illustrated in Tables 1 to 4 in a summary form. Incidentally, the position of the reformed region and the meandering amount of the edge were measured in each eight plates every condition, and their average value was indicated.

TABLE 1

| | | Unit | Example 1 | Example 2 | Example 3 | Example 4 | Example 5 | Example 6 | Example 7 |
|---|---|---|---|---|---|---|---|---|---|
| Process | Laser energy | μJ | 10 | 11 | 12 | 11 | 11 | 11 | 11 |
| condition | Radiation pitch | μm | 10 | 10 | 10 | 5 | 15 | 20 | 30 |
| | Number of scannings | — | 1 | 1 | 1 | 1 | 1 | 1 | 1 |
| Optical | Plate thickness t | μm | 300 | 300 | 300 | 300 | 300 | 300 | 300 |
| glass | Distance a | μm | 133 | 130 | 130 | 130 | 130 | 130 | 130 |
| | Distance b | μm | 125 | 125 | 125 | 125 | 125 | 125 | 125 |
| | Width k | μm | 42 | 45 | 45 | 45 | 45 | 45 | 45 |
| | (Percentage to plate thickness t) | % | 14 | 15 | 15 | 15 | 15 | 15 | 15 |
| | Tip depth R_{d} | μm | 25 | 35 | 65 | 35 | 35 | 35 | 35 |
| | (Percentage to plate thickness t) | % | 8 | 12 | 22 | 12 | 12 | 12 | 12 |
| | 4-point bending strength | Ratio | 1.28 | 1.32 | 1.00 | 1.30 | 1.28 | 1.34 | 1.51 |
| | Meandering amount of edge | μm | 26 | 32 | 51 | — | — | — | — |

TABLE 2

| | | Unit | Example 3 | Example 8 | Example 9 | Example 10 | Example 11 | Example 12 |
|---|---|---|---|---|---|---|---|---|
| Process | Laser energy | μJ | 12 | 12 | 12 | 12 | 12 | 12 |
| condition | Radiation pitch | μm | 10 | 10 | 10 | 10 | 10 | 10 |
| | Number of scannings | — | 1 | 1 | 1 | 1 | 1 | 1 |
| Optical | Plate thickness t | μm | 300 | 300 | 300 | 300 | 300 | 300 |
| glass | Distance a | μm | 130 | 127 | 118 | 115 | 110 | 103 |
| | Distance b | μm | 125 | 125 | 125 | 125 | 125 | 125 |
| | Width k | μm | 45 | 48 | 57 | 60 | 65 | 72 |
| | (Percentage to plate thickness t) | % | 15 | 16 | 19 | 20 | 22 | 24 |
| | Tip depth R_{d} | μm | 65 | 65 | 50 | 45 | 35 | 25 |
| | (Percentage to plate thickness t) | % | 22 | 22 | 17 | 15 | 12 | 8 |
| | 4-point bending strength | Ratio | 1.00 | 1.10 | 1.34 | 1.49 | 1.45 | 1.51 |
| | Meandering amount of edge | μm | 51 | 40 | 21 | 15 | 10 | 10 |

TABLE 3

| | | | Exam- | Exam- | Exam- | Exam- | Exam- | Exam- | Exam- | |
|---|---|---|---|---|---|---|---|---|---|---|
| | | Unit | ple 2 | ple 11 | ple 13 | ple 14 | ple 15 | ple 16 | ple 17 | Example 18 |
| Process | Laser energy | μJ | 11 | 12 | 14 | 16 | 18 | 20 | 8 | 7 |
| condition | Radiation pitch | μm | 10 | 10 | 10 | 10 | 10 | 10 | 10 | 10 |
| | Number of scannings | — | 1 | 1 | 1 | 1 | 1 | 1 | 2 | 2 |
| Optical | Plate thickness t | μm | 300 | 300 | 300 | 300 | 300 | 300 | 300 | 300 |
| glass | Distance a | μm | 130 | 110 | 95 | 88 | 78 | 70 | 100 | Unmeasurable |
| | Distance b | μm | 125 | 125 | 125 | 125 | 125 | 125 | 60 | Unmeasurable |
| | Width k | μm | 45 | 65 | 80 | 87 | 97 | 105 | 140 | Unmeasurable |
| | (Percentage to plate thickness t) | % | 15 | 22 | 27 | 29 | 32 | 35 | 47 | Unmeasurable |
| | Tip depth R_{d} | μm | 35 | 35 | 35 | 35 | 35 | 35 | 10 | Unmeasurable |
| | (Percentage to plate thickness t) | % | 12 | 12 | 12 | 12 | 12 | 12 | 3 | Unmeasurable |
| | 4-point bending strength | Ratio | 1.32 | 1.45 | 1.45 | 1.37 | 1.36 | 1.33 | 1.48 | — |
| | Meandering amount of edge | μm | 32 | 10 | 8 | 8 | 7 | 7 | 7 | — |

TABLE 4

| | | | Exam- | Exam- | Exam- |
|---|---|---|---|---|---|
| | | Unit | ple 19 | ple 20 | ple 21 |
| Process | Laser energy | μJ | 3 | 4 | 5 |
| condition | Radiation pitch | μm | 10 | 10 | 10 |
| | Number of scannings | — | 0 | 5 | 9 |
| Optical | Plate thickness t | μm | 150 | 150 | 150 |
| glass | Distance a | μm | 62 | 58 | 53 |
| | Distance b | μm | 60 | 57 | 52 |
| | Width k | μm | 28 | 35 | 45 |
| | (Percentage to plate | % | 19 | 23 | 30 |
| | thickness t) | | | | |
| | Tip depth R_{d} | μm | 15 | 15 | 10 |
| | (Percentage to plate | % | 10 | 10 | 7 |
| | thickness t) | | | | |
| | 4-point bending strength | Ratio | 2.59 | 2.47 | 2.10 |
| | Meandering amount | μm | 15 | 10 | 7 |
| | of edge | | | | |

Incidentally, in a measurement of the reformed region tip depth R_{d}, an operation of etching after a predetermined amount of polishing of the cut surface was performed until the crack became not confirmed. Concretely, after polishing of 5 μm in a direction orthogonal to the cut surface of the obtained optical glass, the cut surface was immersed in 5 mass % hydrochloric acid for 15 minutes, followed by observation by an optical microscope (magnification: 100 times), and then existence/absence of a latent flaw having become obvious in a 5 mm length range was confirmed. When the latent flaw existed, 10 μm polishing of another piece having been cut under the same condition was performed, followed by confirmation of existence/absence of a latent flaw similarly, and thereafter, samples to which polishings of increased amounts by every 5 μm, i.e., 15 μm, 20 μm, and so on were performed were observed (note that samples of the respective polishing amounts were different pieces cut under the same condition). The polishing amount by which the latent flaw became not confirmed in the 5 mm length range by the above-described method was defined as the reformed region tip depth R_{d}.

Incidentally, for the four-point bending strength, measurement was performed with reference to a “4-point bending strength test” defined in JIS R 1601 (2008). Here, the test piece had a square shape of 5 mm×5 mm in size, a fulcrum pitch was set to 3 mm, a load point pitch was set to 1 mm, and a radius of curvature of tips being the fulcrum and the load point in support members was set to 0.25 mm. Further, the bending strength was measured in 16 plates for one condition, and calculated as their average value. As a measuring machine, AGS-J of SHIMADZU CORPORATION was used. Incidentally, in the item of “ratio” of the 4-point bending strength, relative ratios to the 4-point bending strength of Example 3 being 1.0 were each illustrated.

The meandering amount of edge was defined as the maximum amplitude of meandering of each edge line of the glass substrate (5 mm square) and the amplitude was observed/measured by a length-measuring microscope (magnification: 50 times). The maximum amplitude means, when a virtual square of 5 mm×5 mm is considered, a perpendicular distance to the edge of the virtual square, between the most protruding point and the most dented point from the corresponding edge of the virtual square of respective edge lines of the actual optical glass.

Table 1 shows results of experiments in which the light-collecting shape was not corrected (the light-collecting shape was vertically long in the plate thickness direction by the aberration occurring by the refractive index of the glass), the widths k of the reformed regions were set to almost the same, and the laser energy and the radiation pitch were changed. The reformed region tip depth R_{d} became larger as the laser energy became larger. Further, when the reformed region tip depth R_{d} exceeded 20% of the plate thickness, both 4-point bending strength and meandering amount of edge significantly deteriorated. In the glass substrate of Example 3, the percentage of the reformed region tip depth R_{d} to the plate thickness t exceeded 20%, and the 4-point bending strength was low.

Table 2 shows results of experiments in which the laser energy and the radiation pitch were unchanged and only the light-collecting shape was adjusted to change the width kin the plate thickness direction of the reformed region. The reformed region tip depth R_{d} became smaller as the width k in the thickness direction of the reformed region became larger. At this time, there was a tendency that both 4-point bending strength and meandering amount of edge were improved as the reformed region tip depth R_{d} became smaller. Note that the data of Example 3 is also shown for reference.

Table 3 shows results of experiments in which the radiation pitch was unchanged and the combination of the laser energy, the number of scannings and the light-collecting shape was changed, and the width k in the plate thickness direction of the reformed region was changed. In Examples 2, 11, 13 to 16, the number of scannings was set to one, the reformed region tip depths R_{d} were set to almost the same, and only the width k was increased, and the above results were obtained. There was a tendency that, as the width k in the plate thickness direction of the reformed region became larger, the meandering amount of edge was improved though the 4-point bending strength did not change significantly. Note that data of Examples 2, 11 is also shown for reference.

In Example 17 of Table 3, the number of scannings was increased so as to make the width k in the plate thickness direction of the reformed region large and so as to make the reformed region depth R_{d} further smaller. When the number of scannings was two, both 4-point bending strength and meandering amount were good. Incidentally, though not illustrated in the table, when the number of scannings was three, the width k in the plate thickness direction of the reformed region was as good as 53% of the plate thickness and the meandering amount of edge was as good as 7 μm, but the ratio of the 4-point bending strength (relative ratio to the 4-point bending strength of Example 3 being 1.0) was as low as 0.80. Further, in Example 18, though the number of scannings was two, cutting was not able. The reason is easily considered to be that the laser energy in Example 18 was lower compared with that in Example 17, bringing about the reformed region tip depth R_{d} (percentage to the plate thickness t) of less than 3%.

Table 4 shows results of experiments in a case where the plate thickness of the glass substrate was 150 μm. Even if the plate thickness becomes small, the percentages of the width k in the plate thickness direction of the reformed region to the plate thickness are equal regardless of the plate thickness and cutting was possible, so that practically the width k can be made small. Consequently, the reformed region tip depth R_{d} can also be made small, resulting in that the 4-point bending strength was able to be made significantly higher compared with the case where the plate thickness of the glass substrate was 300 μm.

The optical glass of the present invention is suitably used for a cover glass, a near-infrared cut filter, or the like of a semiconductor device (for example, a device having a solid state imaging device (a CCD, a CMOS or the like)) to be internally housed in an electronic device.

What is claimed is:

1. An optical glass, comprising:
a glass plate comprising a principal surface and an end surface;
a reformed region formed on the end surface;
a plurality of reformed portions formed by light radiated to be focused thereto in the reformed region; and
a crack extending from the reformed portion on the end surface, having a tip portion at a depth of 3 to 20% of a plate thickness of the glass plate from the end surface.

2. The optical glass according to claim 1,
wherein a width in a plate thickness direction of the reformed region is from 13 to 50% of the plate thickness of the glass plate.

3. The optical glass according to claim 1,
wherein the reformed region is formed apart from the principal surface of the optical glass.

4. The optical glass according to claim 1,
wherein the plurality of reformed portions are formed at intervals of 3.0 to 38 μm.

5. The optical glass according to claim 1,
wherein a fracture toughness of the optical glass is from 0.2 to 0.74 MPa·m^{1/2}.

6. The optical glass according to claim 1,
wherein a thermal expansion coefficient of the optical glass is from 75×10⁻⁷ to 150×10⁻⁷.

7. A method of cutting a glass substrate, comprising:
forming selectively a plurality of reformed portions with a crack extending in the glass substrate from at least one of the plurality of reformed portions by radiating light to be focused inside the glass substrate so as to form a reformed region; and
making a fracture occur in a thickness direction of the glass substrate along the reformed region so as to cut the glass substrate,
wherein the crack has a tip portion at a depth of 3 to 20% of a thickness of the glass substrate from a cut surface.

8. The method of cutting a glass substrate according to claim 7,
wherein, in forming the reformed region, a shape of the light to be focused inside the glass substrate is a vertically long shape extending in the plate thickness direction of the glass substrate.

9. The method of cutting a glass substrate according to claim 7,
wherein a width of the reformed region formed by the light is 13 to 50% of a plate thickness of the glass substrate.

10. The method of cutting a glass substrate according to claim 7,
wherein a radiation time per unit pulse by the light is 100 picoseconds to 100 nanoseconds.

11. The method of cutting a glass substrate according to claim 7,
wherein a center wavelength of the light is 532 nm.
